(19) United States
(12) Patent Application Publication
(10) Pub. No.: US 2025/0141378 A1
(43) Pub. Date: May 1, 2025

(54) Determining an Initial Angular Position of a Rotor of a Salient-Pole Permanent Magnet Electrical Machine

(71) Applicant: ABB Schweiz AG, Baden (CH)

(72) Inventors: Sina Kuunsäde, Helsinki (FI); Joni Heikkilä, Helsinki (FI); Matti Eskola, Helsinki (FI)

(21) Appl. No.: 18/909,804

(22) Filed: Oct. 8, 2024

(30) Foreign Application Priority Data
Oct. 25, 2023 (EP) 23205829.7

(51) Int. Cl. H02P 21/18; H02P 25/026; H02P 27/06

(52) U.S. Cl. CPC H02P 21/18; H02P 25/026; H02P 27/06

(57) ABSTRACT

A field of electrical machines and methods and arrangements for controlling electrical machines, and more particularly to determining an initial angular position of a rotor of a salient-pole permanent magnet electrical machine. The method for determining an initial angular position of a rotor of a salient-pole permanent magnet electrical machine connected to a frequency converter includes: performing a first signal injection step, in which first signal injection step an initial angle of the permanent magnet flux axis θ_{d,axis,1} is determined; performing a DC injection is performed, in which a direct current is injected into an idle permanent magnet electrical machine to a DC injection direction; performing a second signal injection step, in which second signal injection step an angle of the permanent magnet flux axis θ_{d,axis,2} is determined; and determining the initial angular position of a rotor of a permanent magnet electrical machine.

### TECHNICAL FIELD

The present invention relates to the field of electrical machines and methods and arrangements for controlling electrical machines, and more particularly to determining an initial angular position of a rotor of a salient-pole permanent magnet electrical machine.

### BACKGROUND

Permanent magnet electrical machines, such as permanent magnet assisted synchronous machines and salient pole permanent magnet synchronous motors, are used for a plurality of applications.

Rotating electrical machines are typically controlled using a frequency converter, and for the controlled operation information regarding electrical behaviour of the machine is required. Such information is fed to the controller of the frequency converter in form of electrical parameters of the machine. For field-oriented control, an accurate initial rotor position is required as initial state for adjusting the direct-quadrature (dq) coordinate system, torque, and flux/voltage estimation etc. Thus, the errors in the initial rotor position has an impact on the starting of a PMSM drive and may lead to the performance degradation.

Initial rotor position estimation is used for determining the angular position of the magnetic flux of a permanent magnet electrical machine, such as a permanent magnet synchronous motor (PMSM). One known initial rotor position estimation method is the direct current injection method i.e., DC injection, which DC injection is used for intentionally aligning the shaft to an intended direction. In a direct current injection method as a DC current is injected, the permanent magnet flux axis, also referred to as d-axis, aligns with the current direction with the surface mounted permanent magnet (SPM) motors. As a result, after said DC injection the initial rotor position will be the same as the DC current direction.

However, with other permanent magnet electrical machines, e.g. in case of highly salient interior permanent magnet (IPM) motors and permanent magnet assisted synchronous reluctance motors (PMaSynRM), the magnetic flux may not align with the DC current direction.

In this type of permanent magnet electrical machines, the magnetic flux usually turns by the DC direction and settles in a position smaller than 90 degrees further from the DC direction, depending on the saliency. This is referred to as the DC parking of the rotor shaft. Therefore, it is not correct to use the DC direction as the initial position of the magnetic flux.

Different types of AC injection methods also exist in the literature, such as e.g. a voltage pulse signal injection method, a sinusoidal high-frequency (HF) signal injection method and a high-frequency (HF) square-wave signal injection method. However, these methods can give 180 degrees error due to the polarity of the permanent magnet flux. Additionally, these methods usually use the saturation behavior of the motor to find the polarity of the permanent magnet flux.

In the following, prior art will be described with reference to the accompanying figures, of which:

FIG. 1A illustrates one example of an angular position of a rotor of a permanent magnet electrical machine before a direct current injection in a rotor angular position estimation method according to the prior art.

FIG. 1B illustrates one example of an angular position of a rotor of a permanent magnet electrical machine after a direct current injection in a rotor angular position estimation method according to the prior art.

FIG. 2A illustrates another example of an angular position of a rotor of a permanent magnet electrical machine before a direct current injection in a rotor angular position estimation method according to the prior art.

FIG. 2B illustrates another example of an angular position of a rotor of a permanent magnet electrical machine after a direct current injection in a rotor angular position estimation method according to the prior art.

FIG. 3A illustrates a third example of an angular position of a rotor of a permanent magnet electrical machine before a direct current injection in a rotor angular position estimation method according to the prior art.

FIG. 3B illustrates a third example of an angular position of a rotor of a permanent magnet electrical machine after a direct current injection in a rotor angular position estimation method according to the prior art.

FIG. 1A illustrates one example of an angular position of a rotor of a permanent magnet electrical machine before a direct current injection in a rotor angular position estimation method according to the prior art. In FIG. 1A an example of DC parking is shown where an angular position of a rotor of a permanent magnet electrical machine before a direct current injection, where DC injection direction is 0 degrees θ_{DC,dir}=0°, i.e., the initial electrical position of the shaft is 36 degrees θ_{PM}=36°. As the direct current injection is performed, this will move the magnetic flux further to 74 degrees.

FIG. 1B illustrates one example of an angular position of a rotor of a permanent magnet electrical machine after a direct current injection in a rotor angular position estimation method according to the prior art. In DC parking example of FIG. 1B an angular position of a rotor of a permanent magnet electrical machine after the direct current injection i.e., the electrical position of the shaft is 74 degrees θ_{PM}=74°.

FIG. 2A illustrates another example of an angular position of a rotor of a permanent magnet electrical machine before a direct current injection in a rotor angular position estimation method according to the prior art. In FIG. 2A another example of DC parking is shown where an angular position of a rotor of a permanent magnet electrical machine before a direct current injection i.e., the initial electrical position of the shaft is 158 degrees θ_{PM}=158°. As the direct current injection is performed, this will move the magnetic flux further to 289 degrees.

FIG. 2B illustrates another example of an angular position of a rotor of a permanent magnet electrical machine after a direct current injection in a rotor angular position estimation method according to the prior art. In another DC parking example of FIG. 2B an angular position of a rotor of a permanent magnet electrical machine after the direct current injection i.e., the electrical position of the shaft is 289 degrees θ_{PM} 289°.

FIG. 3A illustrates a third example of an angular position of a rotor of a permanent magnet electrical machine before a direct current injection in a rotor angular position estimation method according to the prior art. In FIG. 3A a third example of DC parking is shown where an angular position of a rotor of a permanent magnet electrical machine before a direct current injection i.e., the initial electrical position of the shaft is 180 degrees θ_{PM}=180°. As the direct current injection is performed, this will not move the angular position of the rotor, i.e. magnetic flux remain at 180 degrees.

FIG. 3B illustrates a third example of an angular position of a rotor of a permanent magnet electrical machine after a direct current injection in a rotor angular position estimation method according to the prior art. In the third DC parking example of FIG. 3B an angular position of a rotor of a permanent magnet electrical machine after the direct current injection i.e., the electrical position of the shaft remains at 180 degrees θ_{PM} 180°.

In prior art solutions for determining an initial angular position of a rotor of a salient-pole permanent magnet electrical machine, the main problems are the 180 degrees misalignment of the initial angular position of a rotor of a permanent magnet electrical machine and DC parking behavior of the rotor shaft. Also, in prior art solutions for determining an initial angular position of a rotor of a salient-pole permanent magnet electrical machine, a two-phase current measurement sensor or a three-phase current measurement sensor is needed for measuring the current in the direction of the pulse.

In today's demanding environment, there is a need for a more effective and elegant solution for determining an initial angular position of a rotor of a salient-pole permanent magnet electrical machine, which would be more effective, and which would not require a two-phase current measurement sensor or a three-phase current measurement sensor.

Within the technology, there is a specific need for a method for determining an initial angular position of a rotor of a salient-pole permanent magnet electrical machine that would be more effective compared to the current prior art solutions.

### SUMMARY

The object of the invention is to introduce a method for determining an initial angular position of a rotor of a salient-pole permanent magnet electrical machine, which would be more effective than the current prior art solutions. Advantageous embodiments are furthermore presented.

It is brought forward a new method for determining an initial angular position of a rotor of a salient-pole permanent magnet electrical machine connected to a frequency converter, in which method: a first signal injection step is performed, in which first signal injection step an initial angle of the permanent magnet flux axis θ_{d,axis,1} is determined; a DC injection is performed, in which DC injection a direct current is injected into an idle salient-pole permanent magnet electrical machine to a DC injection direction θ_{DC,dir}-θ_{d,axis,1}±θ_{add}, where DC injection direction θ_{DC,dir} is the angle of injected direct current and added angle θ_{add} is an angle defining the shift from the initial angle of the permanent magnet flux axis θ_{d,axis,1}; a second signal injection step is performed, in which second signal injection step an angle of the permanent magnet flux axis θ_{d,axis,2} is determined; and the initial angular position \hat{θ}ᵢₙᵢₜ of a rotor of a salient-pole permanent magnet electrical machine is determined as:

$${\hat{θ}}_{init} = \{ \begin{matrix}{\hat{θ}}_{d , axis , 2} , & 180 ° - \vert \vert {\hat{θ}}_{d , axis , 2} - {θ}_{DC , dir} \vert - 180 ° \vert \leq 90 ° \\ {\hat{θ}}_{d , axis , 2} - 180 ° , & otherwise\end{matrix} .$$

In a preferred embodiment of said method, in said first signal injection step a first pulse test is performed, in which first pulse test number of external pulses are injected into an idle salient-pole permanent magnet electrical machine at selected angles, the ratio of the current to the flux is measured for each injected pulse, and the initial angle of the permanent magnet flux axis θ_{d,axis,1} is determined by performing a discrete Fourier transform (DFT, discrete Fourier transform) on the measured ratios; and in said second signal injection step a second pulse test is performed, in which second pulse test number of external pulses are injected into an idle salient-pole permanent magnet electrical machine at selected angles, the ratio of the current to the flux is measured for each injected pulse, and the angle of the permanent magnet flux axis θ_{d,axis,2} is determined by performing a discrete Fourier transform (DFT, discrete Fourier transform) on the measured ratios.

In a preferred embodiment of said method, in said first signal injection step said initial angle of the permanent magnet flux axis θ_{d,axis,1} is determined by utilizing AC injection and/or wherein in said second signal injection step said angle of the permanent magnet flux axis θ_{d,axis,2} is determined by utilizing AC injection.

In a preferred embodiment of said method, in said first signal injection step said initial angle of the permanent magnet flux axis θ_{d,axis,1} is determined by utilizing voltage pulses signal injection and/or wherein in said second signal injection step said angle of the permanent magnet flux axis θ_{d,axis,2} is determined by utilizing voltage pulses signal injection.

In a preferred embodiment of said method, in said first signal injection step said initial angle of the permanent magnet flux axis θ_{d,axis,1} is determined by utilizing sinusoidal high-frequency (HF) signal injection or high-frequency (HF) square wave signal injection and/or wherein in said second signal injection step said angle of the permanent magnet flux axis θ_{d,axis,2} is determined by utilizing sinusoidal high-frequency (HF) signal injection or high-frequency (HF) square wave signal injection.

In a preferred embodiment of said method, said added angle θ_{add} is 90 degrees.

In a preferred embodiment of said method, said added angle θ_{add} is between 50-130 degrees.

In a preferred embodiment of said method, said added angle θ_{add} is between 30-150 degrees.

In a preferred embodiment of said method, said first pulse test and/or said second pulse test is/are performed as a six-pulse test, in which six-pulse test the ratio of the current to the flux is measured with the pulses at angles of 0, 60, 120, 180, 240 and 300 degrees.

In a preferred embodiment of said method, six voltage pulses are produced in an order that minimizes the possibility of rotating the rotor of the salient-pole permanent magnet electrical machine.

Furthermore, it is brought forward a new frequency converter adapted to be connected to a salient-pole permanent magnet electrical machine, the frequency converter comprising means configured to determine an initial angular position of a rotor of a salient-pole permanent magnet electrical machine by: performing first signal injection step, in which first signal injection step an initial angle of the permanent magnet flux axis θ_{d,axis,1} is determined; performing a DC injection, in which DC injection a direct current is injected into an idle salient-pole permanent magnet electrical machine to a DC injection direction θ_{DC,dir}=θ_{d,axis,1} θ_{add}, where DC injection direction θ_{DC,dir} is the angle of injected direct current and added angle θ_{add} is an angle defining the shift from the initial angle of the permanent magnet flux axis θ_{d,axis,1}; performing second signal injection step, in which second signal injection step an angle of the permanent magnet flux axis θ_{d,axis,2} is determined by; and determining the initial angular position \hat{θ}ᵢₙᵢₜ of a rotor of a permanent magnet electrical machine as:

$${\hat{θ}}_{init} = \{ \begin{matrix}{\hat{θ}}_{d , axis , 2} , & 180 ° \vert \vert {\hat{θ}}_{d , axis , 2} - {θ}_{DC , dir} \vert - 180 ° \vert \leq 90 ° \\ {\hat{θ}}_{d , axis , 2} - 180 ° , & otherwise\end{matrix} .$$

In a preferred embodiment of said frequency converter, in performing said first signal injection step said frequency converter comprises means configured to perform a first pulse test, in which first pulse test number of external pulses are injected into an idle salient-pole permanent magnet electrical machine at selected angles, the ratio of the current to the flux is measured for each injected pulse, and the initial angle of the permanent magnet flux axis θ_{d,axis,1} is determined by performing a discrete Fourier transform (DFT, discrete Fourier transform) on the measured ratios; and in performing said second signal injection step said frequency converter comprises means configured to perform a second pulse test, in which second pulse test number of external pulses are injected into an idle salient-pole permanent magnet electrical machine at selected angles, the ratio of the current to the flux is measured for each injected pulse, and the angle of the permanent magnet flux axis θ_{d,axis,2} is determined by performing a discrete Fourier transform (DFT, discrete Fourier transform) on the measured ratios.

In a preferred embodiment of said frequency converter, in performing said first signal injection step said frequency converter comprises means configured to determine said initial angle of the permanent magnet flux axis θ_{d,axis,1} utilizing AC injection, voltage pulses signal injection, sinusoidal high-frequency (HF) signal injection or high-frequency (HF) square wave signal injection and/or wherein in performing said second signal injection step said frequency converter comprises means configured to determine said angle of the permanent magnet flux axis θ_{d,axis,2} utilizing AC injection, voltage pulses signal injection, sinusoidal high-frequency (HF) signal injection or high-frequency (HF) square wave signal injection.

In a preferred embodiment of said first pulse test and/or said second pulse test is/are performed as a six-pulse test, in which six-pulse test the ratio of the current to the flux is measured with the pulses at angles of 0, 60, 120, 180, 240 and 300 degrees.

Furthermore, it is brought forward a new computer program product comprising computer program code, wherein the execution of the program code in a computer causes the computer of said new frequency converter causes the computer to carry out the steps of said new method.

### BRIEF DESCRIPTION OF THE DRAWINGS

In the following, the present invention will be described in more detail by way of example and with reference to the attached drawings, in which:

FIG. 1A illustrates one example of an angular position of a rotor of a salient-pole permanent magnet electrical machine before a direct current injection in a rotor angular position estimation method according to the prior art.

FIG. 1B illustrates one example of an angular position of a rotor of a salient-pole permanent magnet electrical machine after a direct current injection in a rotor angular position estimation method according to the prior art.

FIG. 2A illustrates another example of an angular position of a rotor of a salient-pole permanent magnet electrical machine before a direct current injection in a rotor angular position estimation method according to the prior art.

FIG. 2B illustrates another example of an angular position of a rotor of a salient-pole permanent magnet electrical machine after a direct current injection in a rotor angular position estimation method according to the prior art.

FIG. 3A illustrates a third example of an angular position of a rotor of a salient-pole permanent magnet electrical machine before a direct current injection in a rotor angular position estimation method according to the prior art.

FIG. 3B illustrates a third example of an angular position of a rotor of a salient-pole permanent magnet electrical machine after a direct current injection in a rotor angular position estimation method according to the prior art.

FIG. 4 illustrates a flow diagram of an embodiment of a method for determining an initial angular position of a rotor of a salient-pole permanent magnet electrical machine according to the present invention.

FIG. 5 illustrates a simplified structure of an embodiment of an inverter of a frequency converter according to the present invention.

FIG. 6 illustrates voltage vectors obtained with the inverter of FIG. 5.

FIG. 7A illustrates an embodiment of an angular position of a rotor of a salient-pole permanent magnet electrical machine after a first signal injection according to the present invention.

FIG. 7B illustrates an embodiment of an angular position of a rotor of a salient-pole permanent magnet electrical machine before and after a direct current injection according to the present invention.

FIG. 7C illustrates an embodiment of an angular position of a rotor of a salient-pole permanent magnet electrical machine after a second signal injection according to the present invention.

FIG. 8A illustrates another embodiment of an angular position of a rotor of a salient-pole permanent magnet electrical machine after a first signal injection according to the present invention.

FIG. 8B illustrates another embodiment of an angular position of a rotor of a salient-pole permanent magnet electrical machine before and after a direct current injection according to the present invention.

FIG. 8C illustrates another embodiment of an angular position of a rotor of a salient-pole permanent magnet electrical machine after a second signal injection according to the present invention.

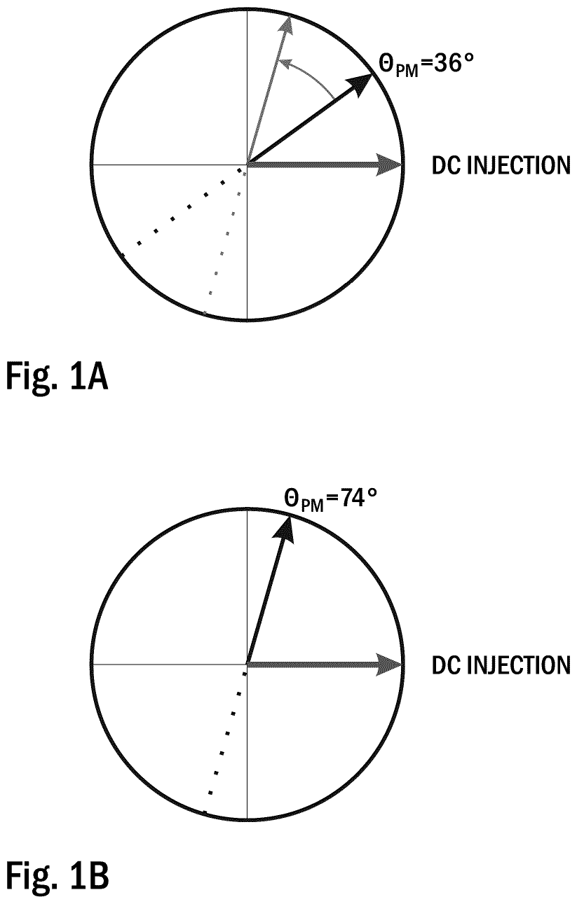

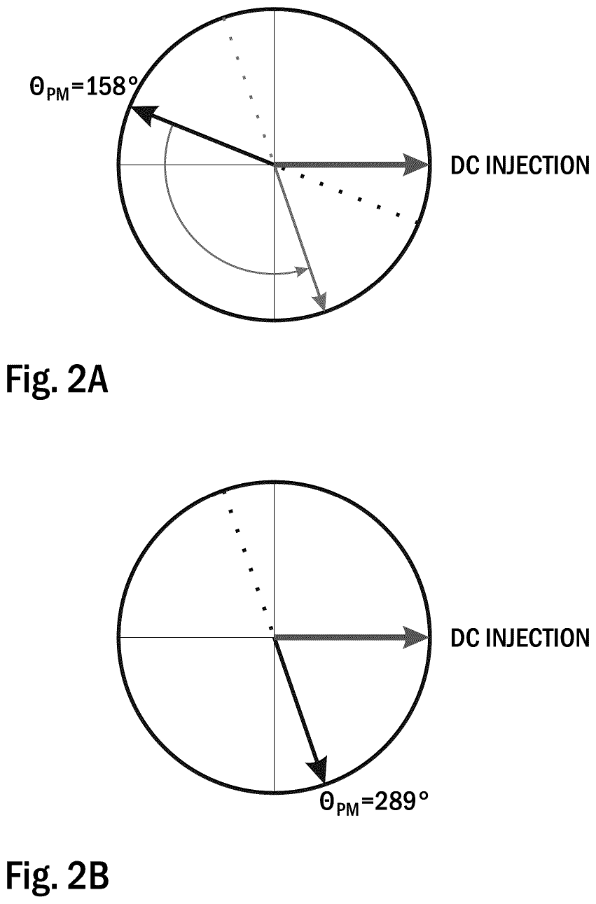

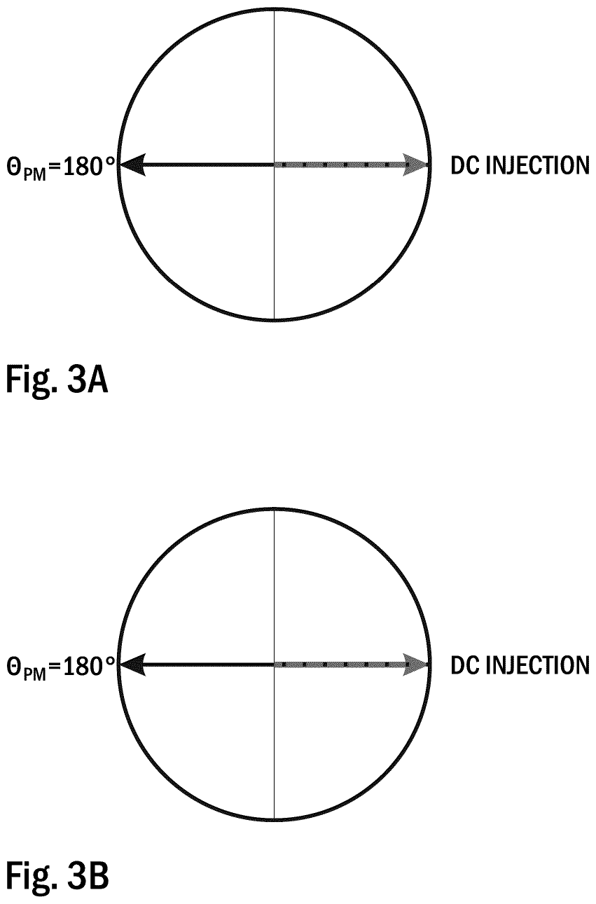

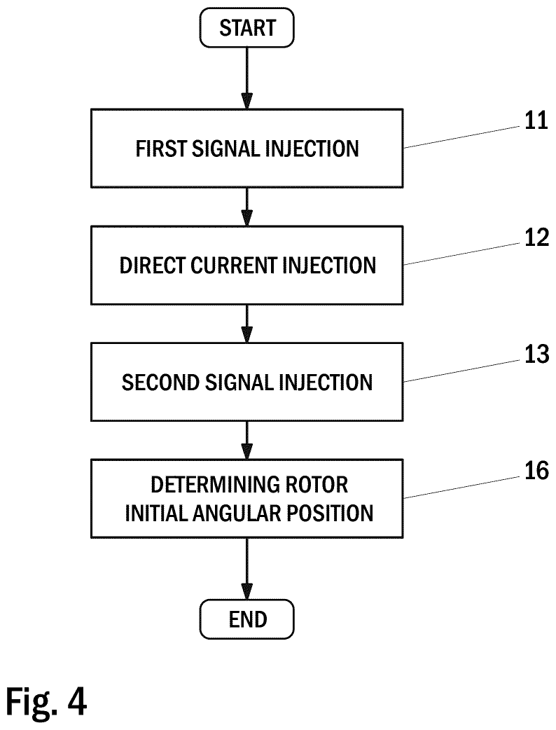

The foregoing aspects, features and advantages of the invention will be apparent from the drawings and the detailed description related thereto. The prior art drawings of FIGS. 1A to 3B have been presented earlier. In the following, the invention will be described in greater detail by means of preferred embodiments with reference to the accompanying drawings of FIGS. 4 to 9.

### DETAILED DESCRIPTION

In the method according to the present invention for determining an initial angular position of a rotor of a salient-pole permanent magnet electrical machine connected to a frequency converter: a first signal injection step is performed, in which first signal injection step an initial angle of the permanent magnet flux axis θ_{d,axis,1} is determined; a DC injection is performed, in which DC injection a direct current is injected into an idle salient-pole permanent magnet electrical machine to a DC injection direction θ_{DC,dir}=θ_{d,axis,1}±θ_{add}, where DC injection direction θ_{DC,dir} is the angle of injected direct current and added angle θ_{add} is an angle defining the shift from the initial angle of the permanent magnet flux axis θ_{d,axis,1}; a second signal injection step is performed, in which second signal injection step an angle of the permanent magnet flux axis after the DC injection θ_{d,axis,2} is determined; and the initial angular position θᵢₙᵢₜ of a rotor of a salient-pole permanent magnet electrical machine is determined as:

$${\hat{θ}}_{init} = \{ \begin{matrix}{\hat{θ}}_{d , axis , 2} , & 180 ° - \vert \vert {\hat{θ}}_{d , axis , 2} - {θ}_{DC , dir} \vert - 180 ° \vert \leq 90 ° \\ {\hat{θ}}_{d , axis , 2} - 180 ° , & otherwise\end{matrix} .$$

FIG. 4 illustrates a flow diagram of an embodiment of a method for determining an initial angular position of a rotor of a salient-pole permanent magnet electrical machine according to the present invention. In the presented embodiment said salient-pole permanent magnet electrical machine is connected to a frequency converter. Said frequency converter may have a current measurement with current sensor/sensors in the intermediate voltage circuit and/or in the three-phase output. In the method according to the present embodiment, a first signal injection 11 is first performed as a first pulse test 11.

In the first pulse test 11 an external pulse (i.e., external flux) is injected into an idle salient-pole permanent magnet electrical machine. When the harmonics, saturation and core losses are ignored, the ratio of the current to the flux in the direction of the pulse can be expressed as

$$\frac{{i}_{s}}{{ψ}_{s}} = \frac{1}{2} ( \frac{1}{{L}_{d}} + \frac{1}{{L}_{q}} ) + \frac{1}{2} ( \frac{1}{{L}_{d}} - \frac{1}{{L}_{q}} ) cos ( 2 ( θ - {θ}_{d , axis} ) ) \qquad ( 1 )$$

where θ is the angle of the external pulse and θ_{d,axis} is an angle of the permanent magnet flux axis. The angle of the permanent magnet flux axis θ_{d,axis} is the angle of d-axis i.e., the electrical angular position of the rotor in stator reference frame.

With the help of the first pulse test 11 the initial angle of the permanent magnet flux axis θ_{d,axis,1} is found. The initial angle of the permanent magnet flux axis θ_{d,axis,1} is the initial angle of d-axis θ_{d,axis,1} i.e., the initial electrical angular position of the rotor in stator reference frame.

In the first pulse test 11 the voltage pulses are produced at selected angles, and with each pulse the current is measured, and the permanent magnet flux is estimated. Thereafter, the ratios of the current to the flux are calculated with the pulses at selected angles. Thereafter, the inductance values L_{d}, L_{q} and the initial angle of d-axis θ_{d,axis,1} are determined by performing a discrete Fourier transform (DFT, discrete Fourier transform) on the measured ratios.

In an embodiment, the first pulse test 11 is carried out as a six-pulse test. In said six-pulse test the ratio of the current to the flux is measured with the pulses at angles of 0, 60, 120, 180, 240 and 300 degrees, the inductance values L_{d}. L_{q} and the initial angle of d-axis θ_{d,axis,1} are determined by performing a discrete Fourier transform (DFT, discrete Fourier transform) on the measured ratios. An example of performing a six-pulse test is further explained in a European Patent specification EP 3 220 535 B1. Said initial angle of d-axis θ_{d,axis,1} is determined as wrapped around 0° and 360°, i.e. 0°≤θ_{d,axis,1}≤360°.

Here a general equation for wrapping an angle around 0° and 360°

$$n = [ \frac{\vert θ \vert}{360} ] \\ θ = \{ \begin{matrix}θ - 360 n , & θ > n \times 360 \\ θ + 360 ( n + 1 ) , & θ < - n \times 360 \\ θ , & otherwise\end{matrix}$$

After performing the first signal injection 11 and determining the initial angle of d-axis θ_{d,axis,1}, a direct current injection 12 is performed to move and park the shaft into a new position (DC, direct current).

In the direct current injection 12 a DC current of low amplitude (e.g., 0.5 times the nominal current value) is injected into an idle salient-pole permanent magnet electrical machine to a DC injection direction defined as

$${θ}_{DC , dir} = {θ}_{d , axis , 1} \pm {θ}_{add} \qquad ( 2 )$$

where DC injection direction θ_{DC,dir} is the angle of injected direct current and added angle θ_{add} is an angle defining the shift from the initial angle of the permanent magnet flux. Said DC injection direction θ_{DC,dir} is determined as wrapped around 0° and 360°, i.e. 0°≤θ_{DC,dir}≤360°.

In an embodiment, the added angle θ_{add} is between 30-150 degrees. In another embodiment, the added angle θ_{add} is between 50-130 degrees. In yet another embodiment, the added angle θ_{add} is 90 degrees.

It has been observed from the simulations and laboratory measurements that the direct current injection 12 guarantees the movement of the shaft and DC parking within 90 degrees (±90°) from the DC direction.

After performing the direct current injection 12, a second signal injection 13 is performed. In the method according to the present embodiment, said second signal injection 13 is performed as a second pulse test 13.

In the second pulse test 13 an external pulse (i.e., external flux) is injected into an idle salient-pole permanent magnet electrical machine. With the help of the second pulse test 13 the angle of the permanent magnet flux axis θ_{d,axis,2} is found. Said angle of the permanent magnet flux axis θ_{d,axis,2} is determined as wrapped around 0° and 360°, i.e. 0°≤θ_{d,axis,2}≤360°. The angle of the permanent magnet flux axis θ_{d,axis,2} is the angle of d-axis after the DC injection θ_{d,axis,2} i.e., the electrical angular position of the rotor in stator reference frame after the DC injection.

In the second pulse test 13 the voltage pulses are produced at selected angles, and with each pulse the current is measured, and the permanent magnet flux is estimated. Thereafter, the ratios of the current to the flux are calculated with the pulses at selected angles. Thereafter, the inductance values L_{d}, L_{q} and the angle of d-axis after the DC injection θ_{d,axis,2} are determined by performing a discrete Fourier transform (DFT, discrete Fourier transform) on the measured ratios.

In an embodiment, the second pulse test is carried out as a six-pulse test. In said six-pulse test the ratio of the current to the flux is measured with the pulses at angles of 0, 60, 120, 180, 240 and 300 degrees, the inductance values L_{d}, L_{q} and the angle of d-axis after the DC injection θ_{d,axis,2} are determined by performing a discrete Fourier transform (DFT, discrete Fourier transform) on the measured ratios.

After performing the second signal injection 13, the initial angular position of a rotor of a salient-pole permanent magnet electrical machine is determined 16 as:

$${\hat{θ}}_{init} = \{ \begin{matrix}{\hat{θ}}_{d , axis , 2} , & 180 ° - \vert \vert {\hat{θ}}_{d , axis , 2} - {θ}_{DC , dir} \vert - 180 ° \vert \leq 90 ° \\ {\hat{θ}}_{d , axis , 2} - 180 ° , & otherwise\end{matrix} \qquad ( 3 )$$

where \hat{θ}ᵢₙᵢₜ is the initial angular position of a rotor of a salient-pole permanent magnet electrical machine.

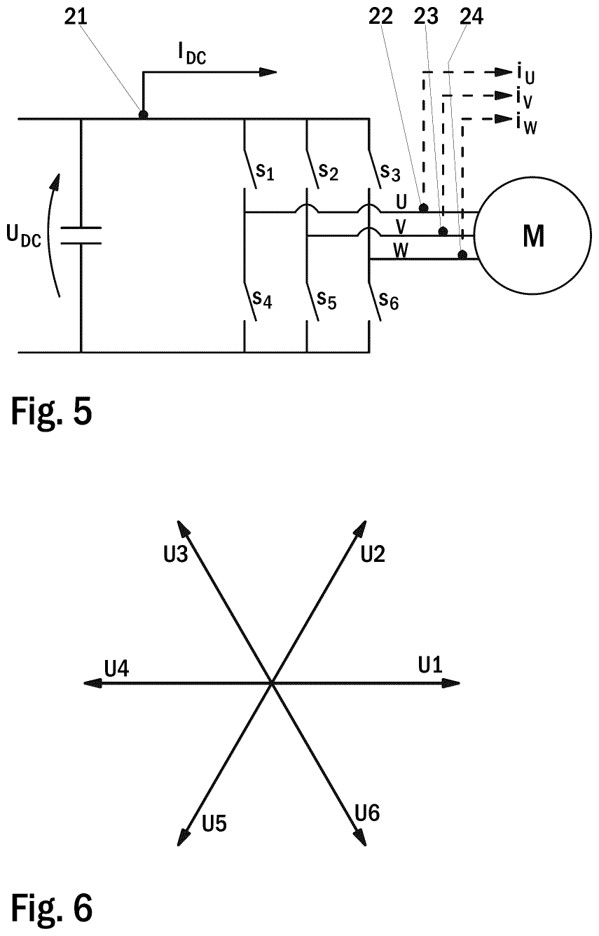

FIG. 5 illustrates a simplified structure of an embodiment of an inverter of a frequency converter according to the present invention. FIG. 5 shows a three-phase inverter of a frequency converter, and the load connected to the output phases. The presented frequency converter is equipped with a current measurement sensor 21 in the intermediate voltage circuit. With the help of the present invention the use of a two-phase current measurement sensor or of a three-phase current measurement sensor is not required. In an alternative solution, the presented frequency converter may comprise a two-phase current measurement sensor or a three-phase current measurement sensor in the intermediate voltage circuit output instead of or in addition to said current measurement sensor 21 in the intermediate voltage circuit. In FIG. 5, the presented frequency converter may have three-phase current measurement sensors 22-24 in the three-phase output as indicated by dashed lines and reference numbers 22-24.

In the method of the present invention voltage pulses are produced or generated with the frequency converter to the salient-pole permanent magnet electrical machine. With reference to FIG. 5, the voltage pulses are produced by selecting suitable switch combinations using the output switches s1-s6 of the frequency converter. The voltage pulses are produced to each output phase of the frequency converter and thus to each phase of the connected machine. For example, by closing switches s1, s5 and s6 a voltage pulse is generated to output phase U and the magnitude of the voltage pulse is the voltage of the intermediate voltage circuit Udc. With the six output switches six different active combinations of the switch states is obtained.

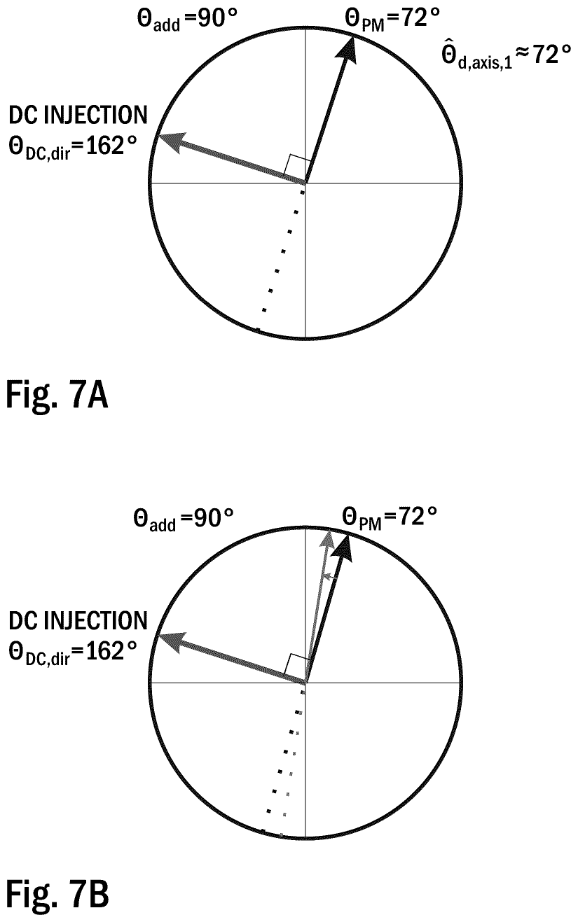

FIG. 6 illustrates voltage vectors obtained with the inverter of FIG. 5. In FIG. 6 the switch combinations are presented as voltage vectors in which the above-mentioned switch combination (s1, s5 and s6 closed) corresponds to vector U1.

In the method of the present invention voltage pulses are produced to each phase of the machine. This means that voltage vectors U1 to U6 are generated. As six voltage pulses are produced, these include a positive and a negative pulse for each phase.

The pulses are preferably produced in an order that minimizes the possibility of rotating the rotor of the machine. Presented in vectors shown in FIG. 6, such an order is, for example, U1, U4, U2, U5, U3, U6. The consecutive voltage vectors are selected to be in as opposite direction as possible so that the produced voltages are not able to produce a rotating magnetic flux in the machine which could rotate the rotor of the machine. In the presented embodiment of FIG. 6 the average torque at the end of the produced pulses is zero. This minimizes the shaft movements.

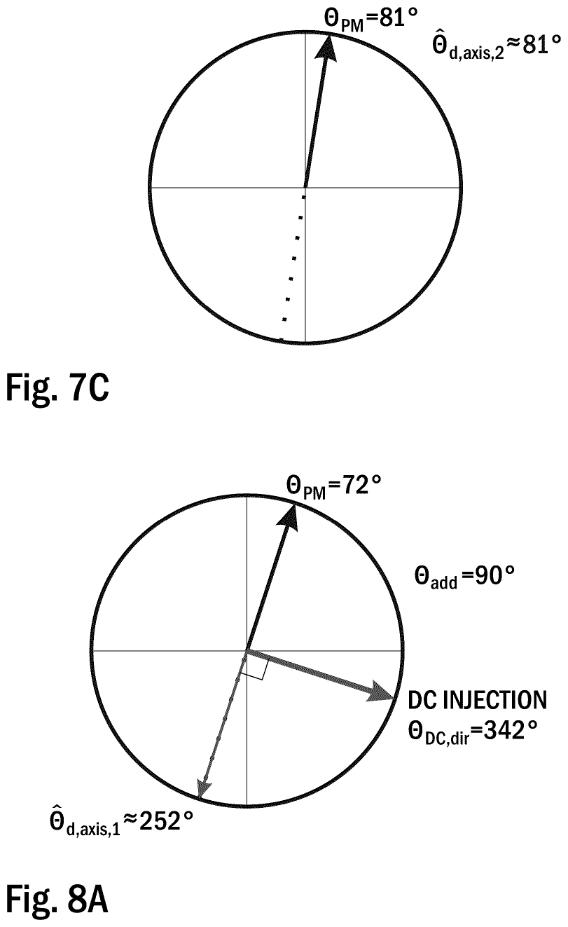

FIG. 7A illustrates an embodiment of an angular position of a rotor of a salient-pole permanent magnet electrical machine after a first signal injection according to the present invention. In the start of the method of the present invention the initial angular position of a rotor is not known. As shown in FIG. 7A an angular position of a rotor of a salient-pole permanent magnet electrical machine after a first signal injection and before a direct current injection i.e., the initial electrical position of the shaft is 72 degrees θ_{PM}=72°. In the start of the method of the present invention the first signal injection step is performed for finding out the initial angle of the permanent magnet flux axis θ_{d,axis,1}. Respectively, the first signal injection step gives us the result for the initial angle of the permanent magnet flux axis θ_{d,axis,1} as 72 degrees \hat{θ}_{d,axis,1}=72°. So, in this stage we know only that the initial electrical position of the shaft is either 72 degrees θ_{PM}=72° or 72 degrees plus 180 degrees θ_{PM}=72°+180°=252°.

In the next step of the method the DC injection is performed to move and park the shaft into a new position, in which a direct current is injected to a DC injection direction θ_{Dc,dir}=θ_{d,axis,1}±θ_{add}. The added angle θ_{add} is an angle defining the shift from the initial angle of the permanent magnet flux axis θ_{d,axis,1}. In the present embodiment, the added angle θ_{add} is 90 degrees. Respectively, the DC injection direction θ_{Dc,dir} is 162 degrees θ_{Dc,dir}=162°.

FIG. 7B illustrates an embodiment of an angular position of a rotor of a salient-pole permanent magnet electrical machine before and after a direct current injection according to the present invention. In FIG. 7B As the direct current injection is performed, this will move the shaft and move the magnetic flux from 72 degrees to 81 degrees. In this stage we do not know the angular position of a rotor after the DC injection. Respectively, in the method of the present invention the second signal injection step is performed for finding out the angle of the permanent magnet flux axis θ_{d,axis,2}.

FIG. 7C illustrates an embodiment of an angular position of a rotor of a salient-pole permanent magnet electrical machine after a second signal injection according to the present invention. In FIG. 7C an angular position of a rotor of a salient-pole permanent magnet electrical machine after a second signal injection i.e., the electrical position of the shaft is 81 degrees θ_{PM}=81°. Respectively, the angle of the permanent magnet flux axis \hat{θ}_{d,axis,2} is 81 degrees \hat{θ}_{d,axis,2}=81°. In the final step of the method of the present invention the initial the initial angular position \hat{θ}ᵢₙᵢₜ of a rotor of a salient-pole permanent magnet electrical machine is determined as:

$${\hat{θ}}_{init} = \{ \begin{matrix}{\hat{θ}}_{d , axis , 2} , & 180 ° - \vert \vert {\hat{θ}}_{d , axis , 2} - {θ}_{DC , dir} \vert - 180 ° \vert \leq 90 ° \\ {\hat{θ}}_{d , axis , 2} - 180 ° , & otherwise\end{matrix} ,$$

this giving us the result that the initial angular position \hat{θ}ᵢₙᵢₜ of the rotor is 81 degrees \hat{θ}ᵢₙᵢₜ=81°.

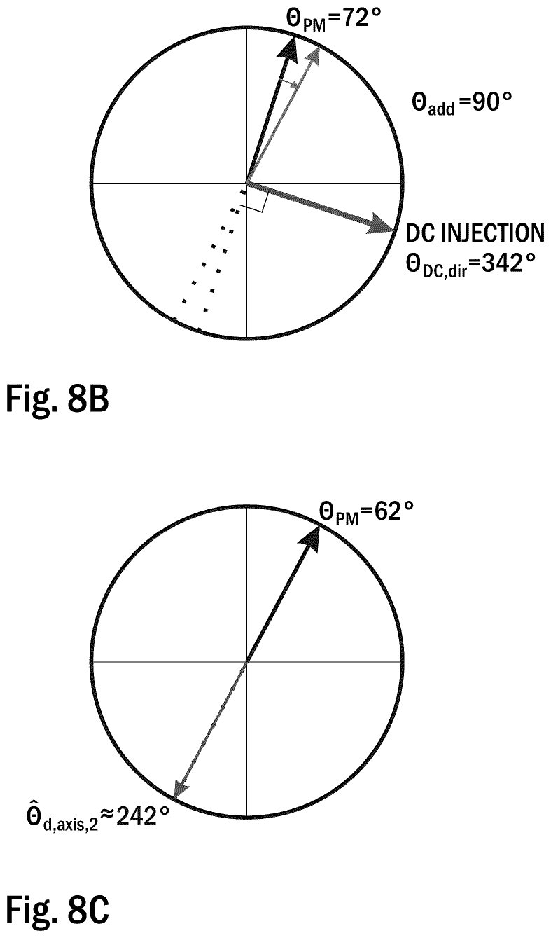

FIG. 8A illustrates another embodiment of an angular position of a rotor of a salient-pole permanent magnet electrical machine after a first signal injection according to the present invention. In the start of the method of the present invention the initial angular position of a rotor is not known. As shown in FIG. 8A an angular position of a rotor of a salient-pole permanent magnet electrical machine after a first signal injection and before a direct current injection i.e., the initial electrical position of the shaft is 72 degrees θ_{PM}=72°. In the start of the method of the present invention the first signal injection step is performed for finding out the initial angle of the permanent magnet flux axis θ_{d,axis,1}. Respectively, the first signal injection step gives us the result for the initial angle of the permanent magnet flux axis \hat{θ}_{d,axis,1} as 252 degrees \hat{θ}_{d,axis,1}=252°. So, in this stage we know only that the initial electrical position of the shaft is either 252 degrees θ_{PM}=252° or 252 degrees minus 180 degrees θ_{PM}=252°−180°=72°.

In the next step of the method the DC injection is performed to move and park the shaft, in which a direct current is injected to a DC injection direction θ_{DC,dir}=θ_{d,axis,1}±θ_{add}. The added angle θ_{add} is an angle defining the shift from the initial angle of the permanent magnet flux axis θ_{d,axis,1}. In the present embodiment, the added angle θ_{add} is 90 degrees. Respectively, the DC injection direction θ_{DC,dir} is 342 degrees θ_{DC,dir}=342°.

FIG. 8B illustrates another embodiment of an angular position of a rotor of a salient-pole permanent magnet electrical machine before and after a direct current injection according to the present invention. In FIG. 8B As the direct current injection is performed, this will move the shaft and move the magnetic flux from 72 degrees to 62 degrees. In this stage we do not know the angular position of a rotor after the DC injection. Respectively, in the method of the present invention the second signal injection step is performed for finding out the angle of the permanent magnet flux axis θ_{d,axis,2}.

FIG. 8C illustrates another embodiment of an angular position of a rotor of a salient-pole permanent magnet electrical machine after a second signal injection according to the present invention. In FIG. 8C an angular position of a rotor of a salient-pole permanent magnet electrical machine after a second signal injection i.e., the electrical position of the shaft is 62 degrees θ_{PM}=62°. Respectively, the angle of the permanent magnet flux axis θ_{d,axis,2} is 242 degrees θ_{d,axis,2}=242°. In the final step of the method of the present invention the initial the initial angular position θᵢₙᵢₜ of a rotor of a salient-pole permanent magnet electrical machine is determined as:

$${\hat{θ}}_{init} = \{ \begin{matrix}{\hat{θ}}_{d , axis , 2} , & 180 ° - \vert \vert {\hat{θ}}_{d , axis , 2} - {θ}_{DC , dir} \vert - 180 ° \vert \leq 90 ° \\ {\hat{θ}}_{d , axis , 2} - 180 ° , & otherwise\end{matrix} ,$$

this giving us the result that the initial angular position \hat{θ}ᵢₙᵢₜ of the rotor is 62 degrees \hat{θ}ᵢₙᵢₜ=62°.

With the help of the solution for determining an initial angular position of a rotor of a salient-pole permanent magnet electrical machine according to the present invention the previously presented problems of 180 degrees misalignment of the initial angular position of a rotor of a salient-pole permanent magnet electrical machine and DC parking behavior of the rotor shaft are solved and/or reduced.

In the of the present solution, a two-phase current measurement sensor or a three-phase current measurement sensor for measuring the current in the direction of the pulse is not needed. In the present solution, a single DC link current sensor is sufficient to measure the current in the direction of the pulse.

The solution according to the present invention provides an effective and elegant solution for determining an initial angular position of a rotor of a salient-pole permanent magnet electrical machine. In the present solution, a single DC link current sensor is sufficient to measure the current in the direction of the pulse. The presented solution is more effective compared to the prior solutions and also eliminates the need for phase current measurements so that the use of a two-phase current measurement sensor or of a three-phase current measurement sensor is not required.

The invention can be implemented in existing frequency converters. Present frequency converters comprise processors and memory that can be utilized in the functions according to embodiments of the invention. Thus, all modifications and configurations required for implementing an embodiment of the invention may be performed as software routines, which may be implemented as added or updated software routines. If the functionality of the invention is implemented by software, such software can be provided as a computer program product comprising computer program code which, when run on a computer, causes the computer or corresponding arrangement to perform the functionality according to the invention as described above. Such a computer program code may be stored or generally embodied on a computer readable medium, such as suitable memory, e.g. a flash memory or a disc memory from which it is loadable to the unit or units executing the program code. In addition, such a computer program code implementing the invention may be loaded to the unit or units executing the computer program code via a suitable data network, for example, and it may replace or update a possibly existing program code.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims and their equivalents.

1. A method for determining an initial angular position of a rotor of a salient-pole permanent magnet electrical machine connected to a frequency converter, in which method:
a first signal injection step is performed, in which first signal injection step an initial angle of the permanent magnet flux axis θ_{d,axis,1} is determined;
a DC injection is performed, in which DC injection a direct current is injected into an idle salient-pole permanent magnet electrical machine to a DC injection direction θ_{DC,dir}=θ_{d,axis,1}±θ_{add}, where DC injection direction θ_{DC,dir} is the angle of injected direct current and added angle θ_{add} is an angle defining the shift from the initial angle of the permanent magnet flux axis θ_{d,axis,1};
a second signal injection step is performed, in which second signal injection step an angle of the permanent magnet flux axis θ_{d,axis,2} is determined; and
the initial angular position \hat{θ}ᵢₙᵢₜ of a rotor of a salient-pole permanent magnet electrical machine is determined as:
$${\hat{θ}}_{init} = \{ \begin{matrix}{\hat{θ}}_{d , axis , 2} , & 180 ° - \vert \vert {\hat{θ}}_{d , axis , 2} - {θ}_{DC , dir} \vert - 180 ° \vert \leq 90 ° \\ {\hat{θ}}_{d , axis , 2} - 180 ° , & otherwise\end{matrix} .$$

2. The method according to claim 1, in which method:
in said first signal injection step a first pulse test is performed, in which first pulse test number of external pulses are injected into an idle salient-pole permanent magnet electrical machine at selected angles, the ratio of the current to the flux is measured for each injected pulse, and the initial angle of the permanent magnet flux axis θ_{d,axis,1} is determined by performing a discrete Fourier transform on the measured ratios; and
in said second signal injection step a second pulse test is performed, in which second pulse test number of external pulses are injected into an idle salient-pole permanent magnet electrical machine at selected angles, the ratio of the current to the flux is measured for each injected pulse, and the angle of the permanent magnet flux axis θ_{d,axis,2} is determined by performing a discrete Fourier transform on the measured ratios.

3. The method according to claim 1, wherein in said first signal injection step said initial angle of the permanent magnet flux axis θ_{d,axis,1} is determined by utilizing AC injection and/or wherein in said second signal injection step said angle of the permanent magnet flux axis θ_{d,axis,2} is determined by utilizing AC injection.

4. The method according to claim 1, wherein in said first signal injection step said initial angle of the permanent magnet flux axis θ_{d,axis,1} is determined by utilizing voltage pulses signal injection and/or wherein in said second signal injection step said angle of the permanent magnet flux axis θ_{d,axis,2} is determined by utilizing voltage pulses signal injection.

5. The method according to claim 1, wherein in said first signal injection step said initial angle of the permanent magnet flux axis θ_{d,axis,1} is determined by utilizing sinusoidal high-frequency signal injection or high-frequency square wave signal injection and/or wherein in said second signal injection step said angle of the permanent magnet flux axis θ_{d,axis,2} is determined by utilizing sinusoidal high-frequency signal injection or high-frequency square wave signal injection.

6. The method according to claim 1, wherein said added angle θ_{add} is 90 degrees.

7. The method according to claim 1, wherein said added angle θ_{add} is between 50-130 degrees.

8. The method according to claim 1 in said added angle θ_{add} is between 30-150 degrees.

9. The method according to claim 2, wherein said first pulse test and/or said second pulse test is/are performed as a six-pulse test, in which six-pulse test the ratio of the current to the flux is measured with the pulses at angles of 0, 60, 120, 180, 240 and 300 degrees.

10. The method according to claim 9, wherein six voltage pulses are produced in an order that minimizes the possibility of rotating the rotor of the salient-pole permanent magnet electrical machine.

11. A frequency converter adapted to be connected to a salient-pole permanent magnet electrical machine, the frequency converter comprising means configured to determine an initial angular position of a rotor of the salient-pole permanent magnet electrical machine by:
performing a first signal injection step, in which first signal injection step an initial angle of the permanent magnet flux axis θ_{d,axis,1} is determined;
performing a DC injection, in which DC injection a direct current is injected into an idle salient-pole permanent magnet electrical machine to a DC injection direction θ_{DC,dir}=θ_{d,axis,1}±θ_{add}, where DC injection direction θ_{DC,dir} is the angle of injected direct current and added angle θ_{add} is an angle defining the shift from the initial angle of the permanent magnet flux axis θ_{d,axis,1};
performing a second signal injection step, in which second signal injection step an angle of the permanent magnet flux axis θ_{d,axis,2} is determined; and
determining the initial angular position \hat{θ}ᵢₙᵢₜ of a rotor of a salient-pole permanent magnet electrical machine as:
$${\hat{θ}}_{init} = \{ \begin{matrix}{\hat{θ}}_{d , axis , 2} , & 180 ° - \vert \vert {\hat{θ}}_{d , axis , 2} - {θ}_{DC , dir} \vert - 180 ° \vert \leq 90 ° \\ {\hat{θ}}_{d , axis , 2} - 180 ° , & otherwise\end{matrix} .$$

12. The frequency converter according to claim 11, wherein
in performing said first signal injection step said frequency converter includes means configured to perform a first pulse test, in which first pulse test number of external pulses are injected into an idle salient-pole permanent magnet electrical machine at selected angles, the ratio of the current to the flux is measured for each injected pulse, and the initial angle of the permanent magnet flux axis θ_{d,axis,1} is determined by performing a discrete Fourier transform on the measured ratios; and
in performing said second signal injection step said frequency converter includes means configured to perform a second pulse test, in which second pulse test number of external pulses are injected into an idle salient-pole permanent magnet electrical machine at selected angles, the ratio of the current to the flux is measured for each injected pulse, and the angle of the permanent magnet flux axis θ_{d,axis,2} is determined by performing a discrete Fourier transform on the measured ratios.

13. The frequency converter according to claim 11, wherein in performing said first signal injection step said frequency converter includes means configured to determine said initial angle of the permanent magnet flux axis θ_{d,axis,1} utilizing AC injection, voltage pulses signal injection, sinusoidal high-frequency signal injection or high-frequency square wave signal injection and/or wherein in performing said second signal injection step said frequency converter includes means configured to determine said angle of the permanent magnet flux axis θ_{d,axis,2} utilizing AC injection, voltage pulses signal injection, sinusoidal high-frequency signal injection or high-frequency square wave signal injection.

14. The frequency converter according to claim 11, wherein said first pulse test and/or said second pulse test is/are performed as a six-pulse test, in which six-pulse test the ratio of the current to the flux is measured with the pulses at angles of 0, 60, 120, 180, 240 and 300 degrees.

15. A computer program product comprising computer program code, wherein execution of the program code in a computer causes the computer of a frequency converter adapted to be connected to a salient-pole permanent magnet electrical machine, the frequency converter comprising means configured to determine an initial angular position of a rotor of the salient-pole permanent magnet electrical machine, to carry out a method including the steps of:
performing a first signal injection step, in which first signal injection step an initial angle of the permanent magnet flux axis θ_{d,axis,1} is determined;
performing a DC injection, in which DC injection a direct current is injected into an idle salient-pole permanent magnet electrical machine to a DC injection direction θ_{DC,dir}=θ_{d,axis,1}±θ_{add}, where DC injection direction θ_{DC,dir} is the angle of injected direct current and added angle θ_{add} is an angle defining the shift from the initial angle of the permanent magnet flux axis θ_{d,axis,1};
performing a second signal injection step, in which second signal injection step an angle of the permanent magnet flux axis θ_{d,axis,2} is determined; and
determining the initial angular position \hat{θ}ᵢₙᵢₜ of a rotor of a salient-pole permanent magnet electrical machine as:
$${\hat{θ}}_{init} = \{ \begin{matrix}{\hat{θ}}_{d , axis , 2} , & 180 ° - \vert \vert {\hat{θ}}_{d , axis , 2} - {θ}_{DC , dir} \vert - 180 ° \vert \leq 90 ° \\ {\hat{θ}}_{d , axis , 2} - 180 ° , & otherwise\end{matrix} .$$

16. The method according to claim 2, wherein in said first signal injection step said initial angle of the permanent magnet flux axis θ_{d,axis,1} is determined by utilizing AC injection and/or wherein in said second signal injection step said angle of the permanent magnet flux axis θ_{d,axis,2} is determined by utilizing AC injection.

17. The method according to claim 2, wherein in said first signal injection step said initial angle of the permanent magnet flux axis θ_{d,axis,1} is determined by utilizing voltage pulses signal injection and/or wherein in said second signal injection step said angle of the permanent magnet flux axis θ_{d,axis,2} is determined by utilizing voltage pulses signal injection.

18. The method according to claim 2, wherein in said first signal injection step said initial angle of the permanent magnet flux axis θ_{d,axis,1} is determined by utilizing sinusoidal high-frequency signal injection or high-frequency square wave signal injection and/or wherein in said second signal injection step said angle of the permanent magnet flux axis θ_{d,axis,2} is determined by utilizing sinusoidal high-frequency signal injection or high-frequency square wave signal injection.

19. The method according to claim 2, wherein said added angle θ_{add} is 90 degrees.

20. The method according to claim 2, wherein said added angle θ_{add} is between 50-130 degrees.
